(19) United States
(12) Patent Application Publication
(10) Pub. No.: US 2008/0174898 A1
(43) Pub. Date: Jul. 24, 2008

(54) Media storage system with modular robotic elements

(76) Inventors: Kelly J. Reasoner, Fort Collins, CO (US); Gregg S. Schmidtke, Fort Collins, CO (US); Jeff Kato, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/657,253

(22) Filed: Jan. 24, 2007

(51) Int. Cl. G11B 15/18

(52) U.S. Cl. 360/69

(57) ABSTRACT

Embodiments include methods, apparatus, and systems for media storage systems with plural robotic elements. One embodiment is a media storage system that has storage libraries connected together to form a stack. Each storage library includes a storage location for holding plural data cartridges and a picker for transporting the data cartridges. A read/write device is located in a housing that is separated from the storage libraries. A cartridge-handling apparatus transports the data cartridges from the storage libraries to the read/write device.

### BACKGROUND

Media storage systems are commonly used to store and retrieve data cartridges so that data may be written to and/or read from the data cartridges. Such media storage systems are also often referred to as autochangers or library storage systems.

A library storage system often includes one or more storage magazines for housing data cartridges. A cartridge-engaging assembly or “picker” engages and transports various data cartridges stored in magazines located in the storage library. For example, the picker retrieves one of the data cartridges from a storage magazine and transports the data cartridge to a read/write device that is located in the housing of the storage library. Following the read/write operation, the picker returns the data cartridge to a storage magazine.

Each individual storage library is relatively expensive since it includes various electronic devices, such as a picker, a power supply, a controller, a read/write device, etc. The picker is highly reliable to ensure that the library storage system also has a high degree of reliability. If the picker fails, then the entire library storage system is down until the picker is exchanged or repaired. The architecture of the library storage system, however, makes it difficult to access and thus exchange a failed picker.

In addition to being expensive, many large library storage systems cannot be incrementally increased in cartridge and drive capacity. Systems require adding drives and cartridges at the same time or adding all the hardware to support them. Such libraries also have low limits or restrictions on adding storage capacity.

### BRIEF DESCRIPTION OF THE DRAWINGS

FIG. 1 is a front perspective view of a high-density media storage system having a plurality of modular storage libraries in accordance with an exemplary embodiment of the present invention.

FIG. 2 is a plan view of one storage library in the high-density media storage system in accordance with an exemplary embodiment of the present invention.

FIG. 3A is a front plan view of a high-density media storage system with two adjacent frames each having a plurality of modular storage libraries in accordance with an exemplary embodiment of the present invention.

FIG. 3B is a top plan view of the high-density media storage system of FIG. 3A in accordance with an exemplary embodiment of the present invention.

FIG. 3C is a side plan view of the high-density media storage system of FIG. 3A in accordance with an exemplary embodiment of the present invention.

FIG. 4 is a rear perspective view of a high-density media storage system with two adjacent frames each having a plurality of modular storage libraries in accordance with an exemplary embodiment of the present invention.

FIG. 5A is a front plan view of a high-density media storage system with three adjacent frames each having a plurality of modular storage libraries in accordance with an exemplary embodiment of the present invention.

FIG. 5B is a top plan view of the high-density media storage system of FIG. 5A in accordance with an exemplary embodiment of the present invention.

FIG. 5C is a side plan view of the high-density media storage system of FIG. 5A in accordance with an exemplary embodiment of the present invention.

### DETAILED DESCRIPTION

Embodiments in accordance with the present invention are directed to apparatus, systems, and methods for media storage systems with plural robotic elements. One embodiment includes a plurality of individual and independent storage libraries vertically stacked to form an array of identical, modular small robotic elements. Each storage library includes a picker and one or more storage magazines for storing multiple data cartridges. The picker engages a data cartridge and transfers it from the storage library to a second picker that is external to the storage library. The second picker transports the data cartridge to a read/write device and then returns the data cartridge to the storage library or other location in the media storage system or other location.

Each of the individual storage libraries manages a small number of data cartridges and is capable of exchanging data cartridges with another robotic element. The individual storage libraries can be hot swapped in the event they fail. Hot swapping enables one or more storage libraries to be exchanged or serviced without impacting operation of the overall media storage system or frame in which the individual storage library is located. For instance, in the event of a failure, the individual storage library is removed from the media storage system; and the cartridge magazines are removable from the storage library and inserted into a new individual storage library. The new individual storage library and cartridge magazines are reconnected to the media storage system without disrupting continuous operation of the media storage system.

In one exemplary embodiment, the data transfer elements (example, the read/write drives) are located outside of the housings of the individual storage libraries. For instance, the data transfer elements are located at the rear of the media storage system where they are accessed and managed with the second picker system (example, one or more larger robotic elements than the robotic element included in each of the individual storage libraries). In this embodiment, the drives are also hot swappable without impacting the overall operation of the media storage system.

The individual storage libraries are modular and easily exchangeable and provide a cost effective mechanism for the media storage system. In one exemplary embodiment, each storage library does not include (i.e., devoid) one or more of read/write devices or drives, power supplies, and system controllers and, thus, is relatively inexpensive to manufacture and maintain. The reliability for each individual storage library can be less reliable than the entire media storage system since the system includes a plurality of identical, modular storage libraries.

The individual storage libraries are easily connected to one another to form or be included in a frame (example, a plurality of vertically or horizontally stacked libraries). In turn, multiple frames are connectable to each other. By connecting individual storage libraries together and frames together, a user can incrementally increase cartridge capacity and/or drive capacity as needed. In one embodiment, the frame provides a structure for supporting or housing the individual storage libraries. As such, individual storage libraries can be removed from, added to, or moved within the frame.

One exemplary embodiment includes one or more frames or chassis. Each frame houses one or more individual storage libraries and also houses or is coupled to one or more read/write drives and power supplies or power system. The power system, storage libraries, and drives can be grown as the demand for storage capacity increases. Each frame also includes or is coupled to one or more large robotic elements or larger pickers that facilitate moving data cartridges from the smaller individual storage libraries to the drives or to other individual storage libraries. For instance, the larger picker can transport a data cartridge from a first storage element in a first frame to a second storage element in a second frame that is adjacent or near the first frame. Both the frames and larger picker are expandable to include other frames so that all data cartridges in the media storage system are controlled with a central controller. In one embodiment, this controller is not located in the individual storage libraries but included in a housing that is adjacent to and/or separated from the stack of individual storage libraries.

Exemplary embodiments enable users to design media storage systems that leverage existing components of smaller individual storage libraries into a larger library. Exemplary embodiments thus reduce costs of parts but increase performance and reliability of the overall media storage system. Further, maintenance is simplified since users can quickly and easily hot swap robotic elements, drives, and power supplies. In the event of a major failure (example, the entire media storage system fails), users are still able to access individual cartridge magazines and data cartridges in each individual storage library. Further, users can incrementally increase or decrease the number of data cartridges, storage magazines, individual storage libraries, frames, drives, power supplies, etc. to meet current storage demands. By way of example, multiple frames can be connected to expand storage capacity. Further, individual storage libraries can be added to existing frames.

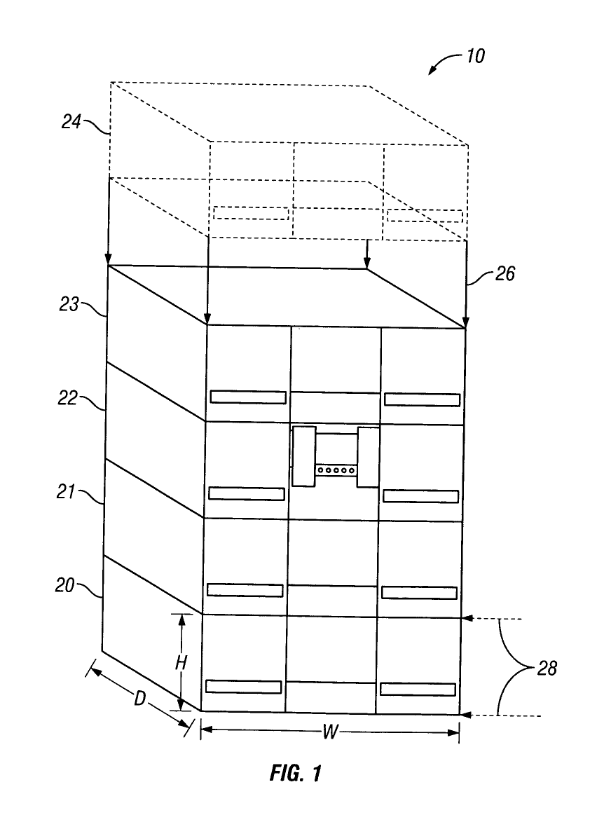

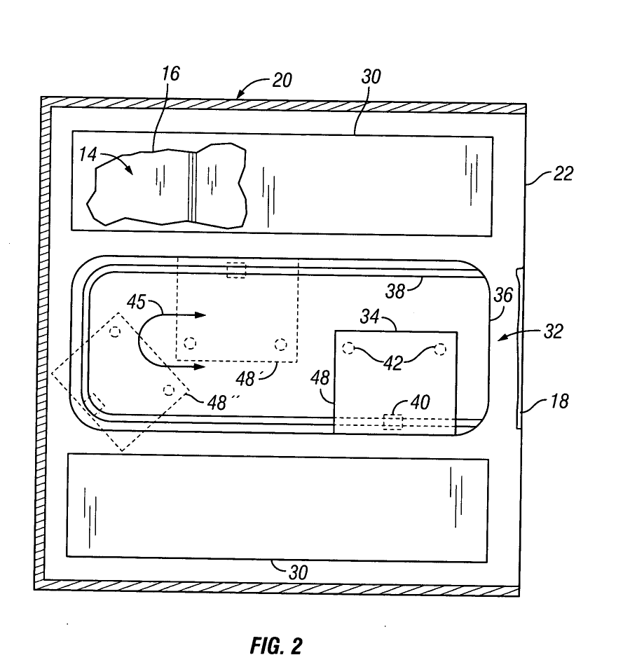

FIG. 1 is a front perspective view of a high-density media storage system 10 having a plurality of modular individual storage libraries 20-23 (referred to generally by reference numeral 20) in accordance with an exemplary embodiment of the present invention. FIG. 2 is a plan view of one storage library 20 in the high-density media storage system in accordance with an exemplary embodiment of the present invention.

As shown in FIGS. 1 and 2, a plurality of data cartridges 14 are stored in individual storage locations 16 (example, for holding storage magazines) in the individual storage libraries 20. Cartridge-handling apparatus 32 is used to transport the data cartridges 14 within the storage library. For example, the data cartridges 14 are delivered to an opening 18 in the housing 22 of an individual storage library 20.

The high-density media storage system 10 includes multiple individual storage libraries 20 that are arranged adjacent one another in a vertically stacked configuration. Additional individual storage libraries 20 are easily added to the high-density media storage system 10 to provide increased storage capacity having more data cartridges 14. For instance, FIG. 1 shows four individual storage libraries 20-23 stacked together with a fifth storage library 24 being added to a top portion of the stack, as illustrated with arrows 26. Alternatively, where fewer individual storage libraries 20 are needed, one or more storage libraries 20 are removed from the media storage system 10.

FIG. 1 shows the individual storage libraries arranged in a vertical stack, but other arrangements are also possible. In another embodiment, for example, individual storage libraries 20 are horizontally stacked next to one another (on either side, in front, or behind), as illustrated by arrows 28 in FIG. 1.

According to one embodiment of the invention, individual storage libraries 20 are sized according to Electronics Industry Association (ETA) standards. One ETA unit (or “U”) is currently defined as having a height of 44.5 millimeters (mm) or 1.75 inches (in). Electronic equipment height is often specified in ETA units. For example, equipment having a height of 44.5 mm is referred to as one ETA unit, or “1 U”. Likewise, equipment having a height of 89 mm is referred to as two EIA units or “2 U”, and so forth. ETA also specifies that equipment conforming to ETA standards be no wider than 450 mm (17.72 in). In addition, ETA also defines uniform, aligned hole spacing for mounting the equipment to the rack systems. Equipment that is sized according to ETA standards is readily mounted to standard ETA cabinets or rack systems.

In one embodiment, each storage library 20 has a height H of about 128 mm (e.g., about three ETA units), a width W of about 438 mm, and a depth D of about 711 mm. Each storage library 20 is configured to fit within a standard ETA cabinet or rack system. In some embodiments, the high-density media storage system 10 has up to fourteen individual storage libraries 20 having an overall height of 42 U, the height of a standard ETA cabinet or rack system. In other embodiments, a larger or fewer number of individual storage libraries are stacked together.

Storage libraries 20 are provided with a number of storage locations 16 for storing multiple data cartridges 14. FIG. 2 shows two separate storage locations, but a individual storage library can contain fewer or more locations. According to one exemplary embodiment, storage magazines 30 are readily added or removed, enabling the user to replace several data cartridges 14 in the individual storage library 20 at a time. In addition, the storage locations 16 are configured to receive horizontally-oriented data cartridges 14, but the data cartridges can be arranged in other configurations as well.

Each storage library 20 includes a minimal number of ancillary electronic devices in order to maintain a low manufacturing cost for an individual storage library. In one exemplary embodiment, each storage library does not include one or more of a power supply, a read/write drive, and a controller. The power supply, read/write drive, and controller are provided in the media storage system outside of the housing of each of the individual storage libraries.

In one exemplary embodiment, each storage library 20 includes a cartridge-handling apparatus 32 for transporting data cartridges 14 within the individual storage library and to and from the opening 18. According to one embodiment, the cartridge-handling apparatus 32 includes a cartridge-engaging assembly or “picker” 34. Picker 34 is configured to engage, withdraw, and retain data cartridge 14 therein for transport in the media storage system 10 by ejecting the data cartridge 14 through opening 18.

As shown, picker 34 is mounted to a carriage 36 in such a manner so as to engage the horizontally-oriented data cartridges 14. In one embodiment, picker 34 is mounted to a guide rail 38 provided on the carriage 36. In the embodiment shown, guide rail 38 defines a generally U-shaped displacement path for travel of the picker 34 adjacent storage locations 16. A suitable drive system may be provided for moving the picker 34 along guide rail 38 through a displacement path 45, shown at various positions 48, 48′, and 48″.

The picker 34 may be mounted to the carriage 36 using various mechanisms. For instance, a mounting bracket 40 provided on the picker engages guide rail 38 such that the mounting bracket slidingly engages the guide rail 38. Alternatively, picker is mounted using a gear assembly, pin-in-track system, etc. Embodiments in accordance with the invention are not limited to any particular type or style of cartridge-handling apparatus.

Various drive systems can be provided for moving the picker 34 through the displacement path. In one embodiment, the drive system includes a drive motor mounted to the picker 34 and operatively associated with a drive pinion. The drive pinion engages a gear rack that is substantially aligned with the guide rail 38. Operation of the drive motor causes the drive pinion to move relative to the gear rack and hence picker 34 to travel through the displacement path. It is understood, however, that other drive systems are also readily provided.

As noted, individual storage libraries are mechanically and/or electrically coupled and vertically stacked on top of one another to form a stack or frame. In one exemplary embodiment, one or more frames are mechanically and/or electrically coupled and horizontally stacked together. Users are able to connect multiple stacks to form a large media storage system. For instance, after a first frame is formed, a second frame is connectable to either side of the first frame. Successive frames are then connected to the second frame or other side of the first frame. This process continues until a desired number of frames and/or individual storage libraries are connected together.

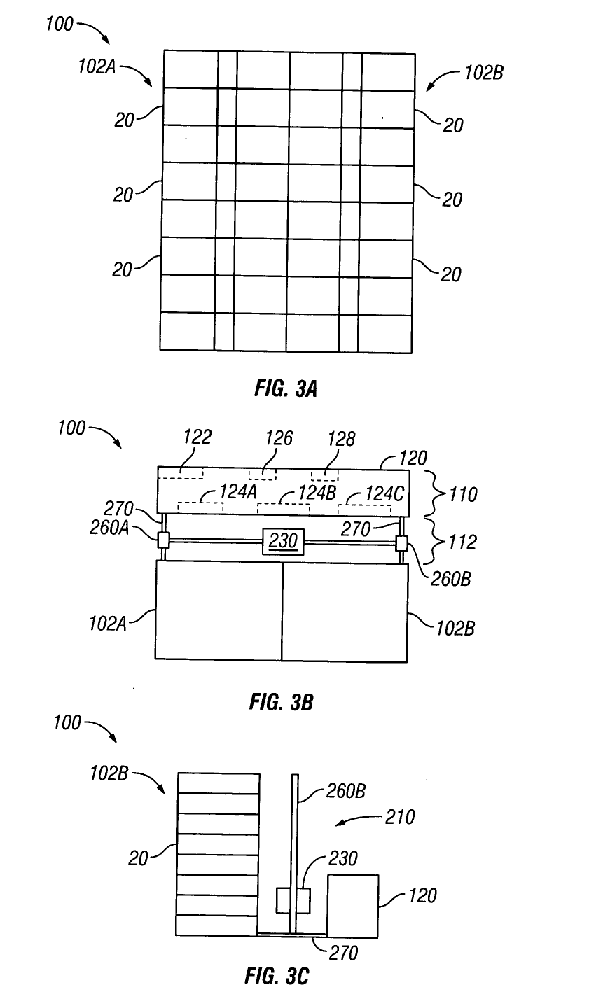

By way of example, FIGS. 3A-3C show various plan views of a high-density media storage system 100 with two adjacent frames 102A, 102B each having a plurality of modular individual and independent storage libraries (each library being shown generally at 20) in accordance with an exemplary embodiment of the present invention. Each frame includes eight individual storage libraries. The frames 102A, 102B are connected in a side-by-side manner to form the media storage system 100.

As best shown in FIGS. 3B, the media storage system includes two areas 110 and 112. Area 110 includes a housing 120 having electrical components for supporting, managing, and controlling operations of the media storage system. By way of example, area 110 includes, but is not limited to, one or more power supplies 122, one or more read/write drives 124A, 124B, 124C, one or more controllers 126, and other ancillary electrical devices 128. As shown, the housing 120 is physically separated and removed from the frames.

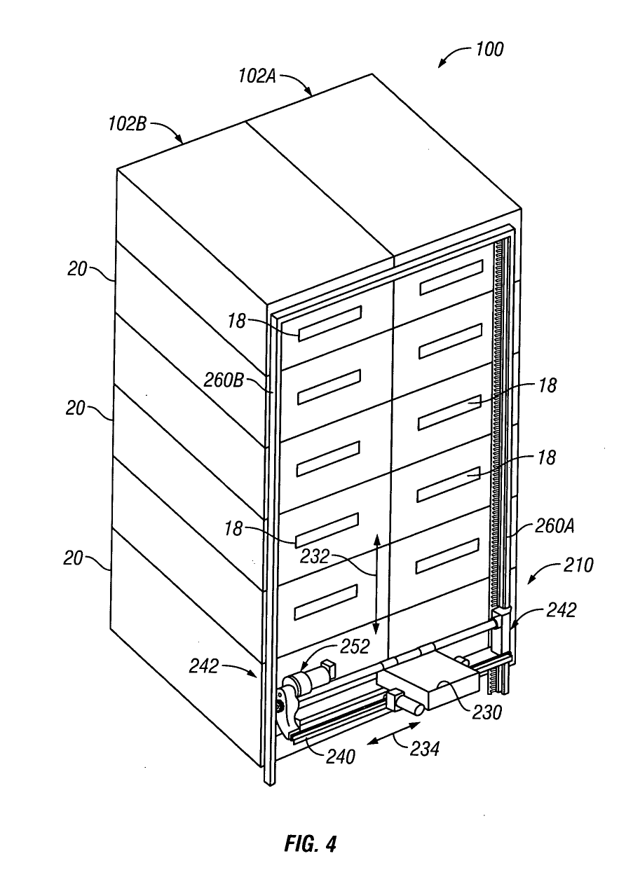

Looking also to FIG. 4, area 112 includes a cartridge-handling apparatus 210 having a cartridge-engaging assembly or “picker” 230. Briefly, the cartridge-handling apparatus 210 operates to effect travel of the picker 230 in media storage system 100 through a first displacement path (illustrated by arrows 232) and a second displacement path (illustrated by arrows 234).

Cartridge-handling apparatus 210 includes any suitable picker 230. Preferably, picker 230 is configured such that it engages a data cartridge, withdraws the data cartridge (example, through opening 18), retains the data cartridge for transportation in the media storage system, and ejects the data cartridge at an intended destination (such as a read/write drive 124 or any one of the individual storage libraries).

As shown best shown in FIG. 4, picker 230 is positioned at one of the openings 18 in one of the individual storage libraries 20. Picker 230 is operated to remove one of the data cartridges from the opening and repositioned the data cartridge in the media storage system at the intended destination, such as one of the read/write devices 124 in housing 120 (see FIG. 3B). For instance, picker 230 ejects the data cartridge into one of the read/write devices for a read and/or write operation. Following the read/write operation, the picker engages the data cartridge and transports it back to the original storage library, a different storage library (such as another individual storage library located within a different frame), or another location in the media storage system.

Exemplary embodiments are not limited to any particular type or style of cartridge-handling apparatus or picker. By way of example, cartridge-handling apparatus 210 includes a carriage 240 operatively associated with a lift assembly 242, as best shown in FIG. 4. Picker 230 is mounted to the carriage 240 such that the carriage 240 and lift assembly 242 enable the picker 230 to travel through the first and second displacement paths in the media storage system.

Carriage 240 and lift assembly 242 include one or more drive motors 252 for moving the picker along the first and second displacement paths. By way of example, the drive motor uses one or more gears, pinion drives, belts, pulleys, rollers, etc. to engage or traverse vertically disposed guide tracks 260A, 260B that are included in the lift assembly 242. These guide tracks are parallel, spaced apart, and extend along the perimeter of the frames 102A, 102B so the picker is able to access each of the individual storage libraries in the media storage system. The carriage 240 is thus movably mounted to the lift assembly 242 so a single picker can access each of the openings 18 of all of the individual storage libraries.

The cartridge-handling apparatus is expandable to accommodate varying or changing sizes of the media storage system. In other words, the cartridge-handling apparatus increases or decreases in size as the number of individual storage libraries or frames increases or decreases. For instance, if another frame is added to the media storage system, then additional guide tracks, carriages, pickers, etc. are added to area 112 so one or more pickers can readily access each of the individual storage libraries. As one example, the guide tracks are formed of sections that interconnect to form a continuous track or framework for the picker(s).

It is also noted that any suitable fastening means may be used to mount the guide tracks, carriages, pickers, etc. in media storage system. Exemplary fastening means include, but are not limited to, screws, clips, mounting brackets, adhesive, snap-fits, or a combination thereof. In addition, the guide tracks are mounted in any suitable manner and can be suspended or mounted to the floor, ceiling, walls of the frames, etc.

Area 110 is electrically coupled to area 112 and frames 102A, 102B through one or more connections 270. For instance, these connections enable the power supplies 122 to provide power to the individual storage libraries 20, cartridge-handling apparatus 210, etc. Further, these connections provide a coupling for data exchange with the storage libraries and enable instructions and commands to be transmitted for controlling and managing the various pickers, lift assemblies, etc. By way of example, each of the individual storage libraries can include one or more hot plug connectors for hot-swapping with the media storage system.

As noted, area 110 is provided with one or more read/write drives or devices 124 that perform read and/or write operations for accessing data stored on the data cartridges. The high-density media storage system, though, is not limited to use with any particular read/write device(s), such as devices that use single or multi-capacity drives (example, drives configured to receive two or more data cartridges). Further, the read/write devices can be modular and easily attached to or removed from area 110 such that read/write capacity increases or decreases to accommodate the size of the media storage system.

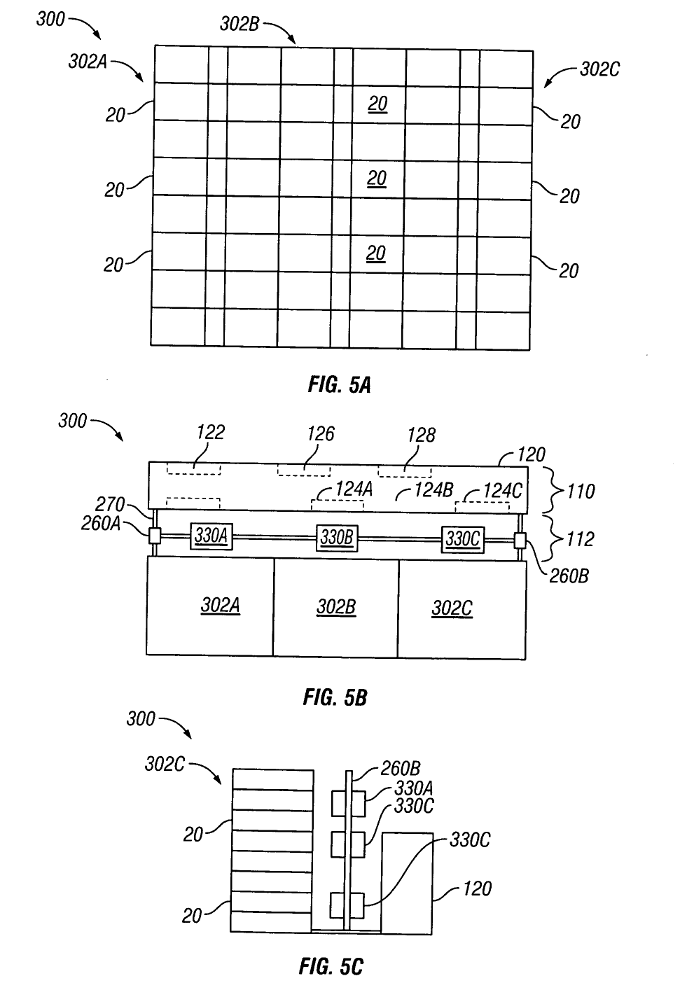

Exemplary embodiments enable the media storage system to easily increase or decrease storage capacity. FIGS. 3A-3C and 4 show a media storage system with two frames. Exemplary embodiments, however, are not limited to any particular number of frames, pickers, individual storage libraries, drives, etc. By way of example, FIGS. 5A-5C show various plan views of a high-density media storage system 300 with three adjacent frames 302A, 302B, 302C each having a plurality of modular individual and independent storage libraries (each library being shown generally at 20) in accordance with an exemplary embodiment of the present invention.

The media storage system 300 of FIGS. 5A-5C is similar to the media storage system discussed in connection with FIGS. 3A-3B, with like numerals being used in both figures. As one difference, the media storage system 300 includes three frames and multiple pickers 330A, 330B, and 330C. Each picker can traverse along the frames 302A-302C such that each picker can access each opening 18 in each individual storage library. Thus, if one picker fails, the media storage system does not also fail. Instead, the other pickers continue to operate. For instance, if picker 330A fails, then pickers 330B and 330C continue to transport data cartridges among the individual storage libraries, read/write drives, and frames. Further, the pickers can simultaneously operate to transport data cartridges between the frames, individual storage libraries themselves, and storage libraries and read/write devices. The system is not limited to any specific number of pickers 330A-330C, but includes one or more individual and/or independent picker robotics.

As used herein, the term “module” means a unit, package, or functional assembly of electronic components for use with other electronic assemblies or electronic components. A module may be an independently-operable unit that is part of a total or larger electronic structure or device. Further, the module may be independently connectable and independently removable from the total or larger electronic structure.

As used herein, the terms “hot swappable” or “hot swapping” means the ability to remove and replace an electronic component of a machine or system while the machine or system continues to operate. Further, as used herein, the word “devoid” means does not include or being without a usual, typical, or expected attribute or accompaniment.

Various devices in the exemplary embodiments are modular and/or hot swappable. Such devices include, but are not limited to, storage libraries, pickers, system controllers, cartridge-handling apparatus, read/write devices, and power supplies. As one example, one or more of the plurality of storage libraries is removable from a frame without impacting continuous operation of the media storage system. Further, one or more of the plurality of storage libraries is added to a frame without impacting continuous operation of the media storage system.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A media storage system, comprising:
a plurality of storage libraries connected together to form a first vertical stack, each storage library including a storage location for holding plural data cartridges and a picker for transporting the data cartridges;
a read/write device in a housing that is separated from the storage libraries; and
a first cartridge-handling apparatus for transporting the data cartridges from the plurality of storage libraries to the read/write device.

2) The media storage system of claim 1, wherein each of the plurality of storage libraries does not include either a read/write device or a power supply.

3) The media storage system of claim 1, wherein the plurality of storage libraries are modular and hot-swappable.

4) The media storage system of claim 1 further comprising, a second cartridge-handling apparatus for transporting the data cartridges from the plurality of storage libraries to the read/write device and to multiple individual storage libraries.

5) The media storage system of claim 1 further comprising, a plurality of storage libraries connected together to form a second vertical stack, wherein the first and second vertical stacks are connected to each other so the first cartridge-handling apparatus accesses data cartridges from the first and second vertical stacks.

6) The media storage system of claim 1, wherein one of the plurality of storage libraries is removable from the first vertical stack without impacting continuous operation of the media storage system.

7) The media storage system of claim 1, wherein the housing of the read/write device is physically separate and removed from the first stack.

8) A media storage system, comprising:
a first frame having plural storage libraries stacked together;
a second frame adjacent the first frame and having plural storage libraries stacked together, each storage library being devoid of a read/write device but including a storage location for holding plural data cartridges and a picker for transporting the data cartridges;
plural read/write devices remote from the first and second frames; and
plural cartridge-handling apparatus for transporting the data cartridges away from the first and second frames to another device.

9) The media storage system of claim 8, wherein each cartridge-handling apparatus has access to each of the storage libraries in the first and second frames.

10) The media storage system of claim 8 further comprising, a third frame adjacent the second frame and having plural storage libraries stacked together, the first, second, and third frames being connected together.

11) The media storage system of claim 8, wherein each storage library is devoid of a power supply, power supplies for the storage libraries being remote from the first and second frames.

12) The media storage system of claim 8, wherein the plural storage libraries are modular and hot-swappable.

13) The media storage system of claim 8, wherein the plural cartridge-handling apparatus are located between (1) the first and second frames and (2) the plural read/write devices.

14) The media storage system of claim 8, wherein the plural storage libraries are modular such that an additional storage library is added to the first frame without disrupting operation of the media storage system

15) A media storage system, comprising:
a plurality of storage libraries connected together to form a first stack, each storage library having a housing that is devoid of a read/write device but includes (1) a storage location for holding plural data cartridges and (2) a picker for transporting the data cartridges to an opening in the housing;
a read/write device remote from the first stack of storage libraries; and
a first cartridge-handling apparatus for transporting the data cartridges from the plurality of storage libraries to the read/write device.

16) The media storage system of claim 15 further comprising, a plurality of storage libraries connected together to form a second stack that is removably connectable to the first stack.

17) The media storage system of claim 15 further comprising, a second cartridge-handling apparatus for transporting the data cartridges from the plurality of storage libraries to the read/write device, the first and second cartridge-handling apparatus being hot-swappable and simultaneously operating to engage data cartridges.

18) The media storage system of claim 15 wherein the plurality of storage libraries are modular and hot-swappable.

19) The media storage system of claim 15 wherein one of the plurality of storage libraries is removable from the first vertical stack without impacting continuous operation of the media storage system.

20) The media storage system of claim 15 wherein the read/write device is physically separate and removed from the first stack.
